(19) United States
(12) Patent Application Publication
(10) Pub. No.: US 2019/0016039 A1
(43) Pub. Date: Jan. 17, 2019

(54) METHOD AND PRESS FOR MAKING A PRESS FROM FIBER COMPOSITE

(71) Applicant: Siempelkamp Maschinen- und Anlagenbau GmbH, Krefeld (DE)

(72) Inventors: Reinhold DREES, Krefeld (DE); Michael SCHOELER, Rheurdt (DE)

(21) Appl. No.: 16/066,261

(22) PCT Filed: Jan. 10, 2017
(86) PCT No.: PCT/EP2017/050406

§ 371 Date: Jun. 26, 2018

(30) Foreign Application Priority Data
Jan. 29, 2016 (DE) 10 2016 101 641.1

(51) Int. Cl. B29C 51/36; B29C 70/44; B30B 5/02

(52) U.S. Cl. CPC B29C 51/365; B30B 5/02; B29C 70/44

(57) ABSTRACT

The invention relates to a method and a press for producing a component from a fiber composite material by deforming a thermoplastic semi-finished product, in particular an organic sheet (2), in a membrane press (1), wherein a mold (4) has been or is arranged in the membrane press (1), wherein at least one semi-finished product/organic sheet (2) is positioned on top of or against the mold as a workpiece, and wherein an elastically stretchable membrane (11) is preloaded while stretched over the mold (4) with the semi-finished product/organic sheet (2) arranged therebetween. At the same time, the semi-finished product/organic sheet (2) is deformed in order to form the component, in that a vacuum is applied to the membrane (11) on the side facing the mold and a positive pressure is optionally additionally applied to the membrane on the side facing away from the mold such that the semi-finished product/organic sheet (2) is shaped onto the mold. A mold is used which is permeable to air at least in some areas and which is produced, for example, from porous aluminum.

The invention relates to a method and a press for making a (three-dimensional) part from fiber composite by deformation of a (two-dimensional) thermoplastic semifinished product, for example an organic sheet.

In the context of the invention, an “organic sheet” is a plate-shaped (consolidated) semifinished product consisting of fibers embedded in a matrix of thermoplastic plastic. The fibers can be continuous or long, for example in the form of a fiber weave or fiber nonwoven. The fibers can be for example of carbon, glass, or aramid. Such organic sheets are used as fiber composites for making parts (for example lightweight design) for aerospace engineering (for example aircraft construction) and for automotive engineering (for example in automobile construction). The use of the thermoplastic fiber matrix allows one to (thermo) shape such organic sheets similarly to metal sheets, so that, in practice, methods for working metal sheets are used during the processing of organic sheets and during the manufacture of parts from such organic sheets.

For instance, DE 10 2011 115 730 describes a method of shaping thermoplastic semifinished fiber plates with oriented fibers into three-dimensionally shaped thermoplastic semifinished products with defined degrees of orientation, with the semifinished fiber plate that is formed from an organic sheet being heated by a heater to a temperature below a softening temperature of the thermoplastic resin, and with the semifinished fiber plate being positioned on a molding module of the desired three-dimensional shape. A fluid is then fed into the molding chamber so that the heated semifinished fiber plate is pressed against the molding module and is thus deformed into the three-dimensionally shaped thermoplastic semifinished product.

Other methods for processing organic sheets and/or parts made from such organic sheets are described for example in DE 10 2013 105 080, DE 10 2011 111 233, and DE 10 2011 111 232.

Alternatively, DE 198 59 798 describes the manufacture of molded bodies from fiber composites by the so-called prepreg method. Thin layers of fibers embedded in partially cured resin are laminated together until a preform of the molded body has been created. This preform is subsequently cured under mechanical pressure with the simultaneous application of a vacuum to draw air bubbles out of the preform by heating. This is typically performed in an autoclave holding the preform on a negative mold and is covered by a flexible membrane. The flexible membrane is sealed off against the negative mold. A layer of woven material is also placed between the preform and the membrane that serves to absorb excess resin and to form a vacuum zone, the so-called vacuum bag. The interior of the vacuum bag is connected to a vacuum source.

Taking this as a point of departure, DE 198 59 798 describes the manufacture of molded bodies from fiber composites that builds upon an RTM method. A fiber mat is placed on a rigid negative mold, and the fiber mat is covered with a flexible membrane. The membrane is sealed around the fiber mat relative to the negative mold, and the space between the negative mold and the membrane that is formed in this way is evacuated, and a static superatmospheric pressure is applied to the rear face of the membrane turned away from the negative mold. A quantity of liquid resin is then injected into the space between the negative mold and the membrane at an injection pressure that is greater than the superatmospheric pressure on the rear face of the membrane. The resin is heated on the rear face of the membrane by the heated negative mold under the effect of the superatmospheric pressure and cured at least partially. The superatmospheric pressure on the rear face of the membrane is then reduced, and the molded body with the fiber mat embedded into the at least partially cured resin is demolded. The negative mold can be continuously heated, and the membrane can be cooled on its rear face.

Similar methods of using a membrane press and a resin is injected into the mold space are described for example in EP 1 420 940 [US 2004/0219244] or DE 694 09 618.

DE 40 40 746 [U.S. Pat. No. 5,145,621] describes a method of compressing, in a membrane press, a composite material body with a structure of fibers embedded in a matrix that reinforce uncompressed layers.

It is the object of the invention to provide a method of making (lightweight) parts from fiber composites of high quality and high stability.

To attain this object, the invention teaches a method of making a part from fiber composite by deformation of a thermoplastic semifinished product, for example organic sheet, in a membrane press, wherein
a mold is provided in the membrane press, and at least one semifinished product is placed as a workpiece against or on the mold, and an elastic membrane is flexibly stretched over the mold with interposition of the semifinished product, and
the semifinished product is deformed so as to form the part by applying a subatmospheric pressure to the membrane on the face facing the mold so that the organic sheet is shaped against the mold. The method is characterized in that an at least partially air-permeable mold is used through which air is sucked during the generation of the negative pressure.

The invention proceeds in this regard initially from the insight that high-stability and high-precision three-dimensional fiber composite parts can be manufactured economically from organic sheets, for example, in a membrane press, with such organic sheets being available as (two-dimensional) plate-shaped consolidated semifinished products and outstandingly suitable for deforming into three-dimensional structures by applying pressure and heat, which structures can be used in aircraft construction, automobile construction, or the like. Unlike in conventional prepreg methods, however, it is preferred not to use mats that are only partially cured, but rather consolidated semifinished products in the form of organic sheets, so that there is no injection of liquid resins or the like into the press. Especially preferably, an organic sheet is used as a prefabricated semifinished product that is composed of a plurality of organic sheet layers that are placed together and optionally joined together before introduction into the press. Highly stable parts can be made in this way that can also have a certain thickness or wall thickness. Nonetheless, flawless shaping is achieved in the membrane press in the context of the invention, since a (highly) elastic membrane is clamped into the press that is elastically stretched and clamped over the mold with interposition of the organic sheet. By the application of subatmospheric pressure to one face and, optionally, superatmospheric pressure to the other face, flawless shaping then occurs, with the highly elastic membrane stretching strongly and perfectly against the desired contour and, with interposition of the organic sheet, against the contour of the mold. The application of subatmospheric pressure to one face and, optionally, (very high) superatmospheric pressure to the other face, makes it possible to shape consolidated organic sheets into parts having a complex structure and small radii, so for example that even U-shaped profiles with and without undercut can be manufactured flawlessly. The high pressures in the membrane press ensure perfect venting of the workpiece, so that the formation of pores is prevented and/or pores can be removed. Overall, the manufactured parts are characterized by very high surface quality and considerable stability. However, the invention also covers the shaping of other thermoplastic semifinished products. For instance, several (non-consolidated) individual thermoplastic layers (made of fiber composite) can also be inserted in the press and processed as a semifinished product.

Overall, it is possible to make highly stable, lightweight parts for aircraft construction, for example for bearing surfaces or bearing surface parts. For example, profiles can be made that are usable as a part of a landing flap.

According to the invention, the mold is air-permeable at least in some areas. This can be achieved, for example, by the use of a mold made of a porous material. Preferably, a mold made of a porous light metal, especially preferably of porous aluminum or a porous aluminum alloy, is used. The invention proceeds in this regard from the discovery that the manufacturing process can be optimized by using such a mold, since this creates the opportunity to apply a full-surface vacuum over the entire surface to be shaped. The porous material is preferably an open-pore porous material, for example open-pore porous aluminum or an open-pore porous aluminum alloy.

A material is preferably used that has a filter mesh of from 5 μm to 250 μm, for example 30 μm to 120 μm, and/or a pore size of from 0.1 mm to 3 mm, for example 0.2 mm to 1.5 mm.

Pore size refers here to the (maximum) diameter of the pores. Filter mesh refers here to the (minimum) width of the (passage) openings between the pores of the open-pore structure.

The invention relates fundamentally to the shaping of thermoplastic semifinished products. Organic sheets are especially preferably used as semifinished products.

Semifinished products or organic sheets are preferably used whose fibers are of carbon, glass, and/or aramid.

Thermoplastics are especially preferably used that are stable at high temperatures, such as polyether ether ketone (PEEK) or polyphenylene sulfide (PPS). Alternatively, however, polypropylene (PP), polyamide (PA), or polyurethane (TPU) can also be used, depending on the requirements and field of application. The materials used can be used in (consolidated) organic sheets or organic sheet layers or, alternatively, also in (non-consolidated) semifinished fiber products or layers thereof.

During manufacture, it is advantageous for the semifinished product/organic sheet to be heated before and/or after placement into the press in order to optimize the shaping process. It is advantageous for the respective semifinished product or organic sheet to be heated to a temperature above the glass transition temperature. Depending on the material or organic sheet, and depending on the thermoplastic resin, it can be advantageous to heat the organic sheet to a temperature of greater than 180° C., for example greater than 200° C.

Alternatively or in addition, it is advantageous to heat the mold or at least the surface facing the organic sheet before and/or during shaping. Here, too, it can also be advantageous to heat the mold, more particularly its surface, to a temperature above the glass transition temperature of the thermoplastic resin, for example to a temperature of greater than 180° C., for example greater than 200° C.

Moreover, it is alternatively or also advantageous if the fluid medium that applies pressure to the membrane, such as a pressurized gas, for example, is heated in order to optimize the heat input and improve hot shaping.

Preferably, not only is a subatmospheric pressure applied to the face of the membrane facing the mold, but rather a superatmospheric pressure is also applied to the face of the membrane turned away, with it being especially preferably possible for a superatmospheric pressure of at least 10 bar, for example at least 20 bar to be employed. According to the invention, high pressures are thus used in order to take into account the fact that consolidated organic sheets, for example, are being processed or shaped.

A vacuum bag is preferably not used for this purpose as is common with membrane presses when processing prepregs or for the injection of resin, but rather a highly elastic membrane is stretched over the mold. For example, it can be secured to the lower element of the press and stretched over the mold. Alternatively, however, the membrane can also be secured to the lower element of the press in an elastically biased manner and then stretched over the mold as the press is closed.

In principle, membranes made of rubber can be used. In consideration of the fact that plastics are preferably used that are stable at high temperatures, the invention recommends the use of a membrane that is made of a highly elastic yet thermally stable material such as silicone or a silicone-based material. Existing silicone membranes can be used that have a stretch-to-break of at least 500%, preferably at least 600%. The membrane preferably has a thickness of at least 1 mm, especially preferably at least 2 mm.

As described above, a prefabricated semifinished product comprised of a plurality of organic sheet layers or a large number of organic sheet layers that are placed together before placement into the press and optionally joined together is especially preferably used. It lies within the scope of the invention, however, for the organic sheet layers to be placed together individually and pressed collectively. Preferably, however, the organic sheet layers are previously joined together (in a desired arrangement), for example by welding and/or gluing, in which case an intimate bond is created subsequently during shaping in the membrane press. Alternatively, it lies within the scope of the invention for the individual organic sheet layers to be combined into a unitary organic sheet in a prepress.

In that case, a large number of layers can be used, for example, five layers, preferably at least ten layers. For highly stable parts (for aircraft construction, for example), more than twenty layers can also be joined together to form one organic sheet. Moreover, a plurality of (non-consolidated) layers can be preferably inserted (loosely) into the press, for example at least five layers, preferably at least ten layers. The processing of individual layers provides the advantage that they can slide freely against one another during shaping, so that, in particular, even complicated structures that potentially have several undercuts can be made flawlessly.

It lies within the scope of the invention for individual layers having different fiber orientations to be used and/or for the individual layers to be stacked such that their fibers do not run parallel, but rather at a predefined angle. Especially stable organic sheets and corresponding parts can be made in this way. The characteristics and geometry of the part can be influenced outstandingly by the selection and orientation of the individual layers. For example, the possibility exists of providing individual layers in different sizes to form a semifinished product, for example an organic sheet, whose thickness varies over its surface. In areas where more layers are present, for example, workpieces with a greater thickness or wall thickness are created than in other areas. Similarly, it is possible to position the individual layers such that a desired edge geometry of the part is created during deformation by offsetting of the individual layers relative to one another. For example, if the individual layers are flush in the non-deformed state, a sloped edge geometry can be made by the deformation and, conversely, a straight edge geometry can be achieved by a skew arrangement of the individual layers in the edge region as a result of deformation. It may be desirable, for example, to produce parts with beveled edges in order to make better joining surfaces available for further processing.

The object of the invention is also a vacuum-assisted press for making a part from fiber composite, particularly employing the described method. Such a press is constructed as a membrane press that has a lower element against/on which a mold is arranged and an upper element that has a pressure case that can be sealed off against the lower element. Moreover, a membrane is provided that can be stretched over the mold.

The press also has at least one press cylinder that acts on the press upper and/or lower element. Moreover, the press has a vacuum pump that can create a subatmospheric pressure on one face of the membrane, for example on the lower face. Optionally, a superatmospheric pressure pump can be provided that can apply a superatmospheric pressure to the other face of the membrane.

According to the invention, the mold is air-permeable at least in some areas. It is thus possible for the mold to be made at least partially of a porous material. Especially preferably, the mold is made at least partially of porous light metal, for example porous aluminum, or a porous aluminum alloy.

The press can be embodied such that the mold and/or the lower element can be heated by a heater. Moreover, the press is set up such that the fluid medium that applies pressure to the membrane can be heated by the heater near for example the intake for the fluid medium.

The possibility exists for the membrane to be secured to the lower element and stretched over the mold. Alternatively, it is possible for the membrane to be secured in an elastically biased manner to the upper element, for example to the pressure case.

The invention is explained in further detail below with reference to a schematic drawing, that illustrates only one embodiment. In the figures,

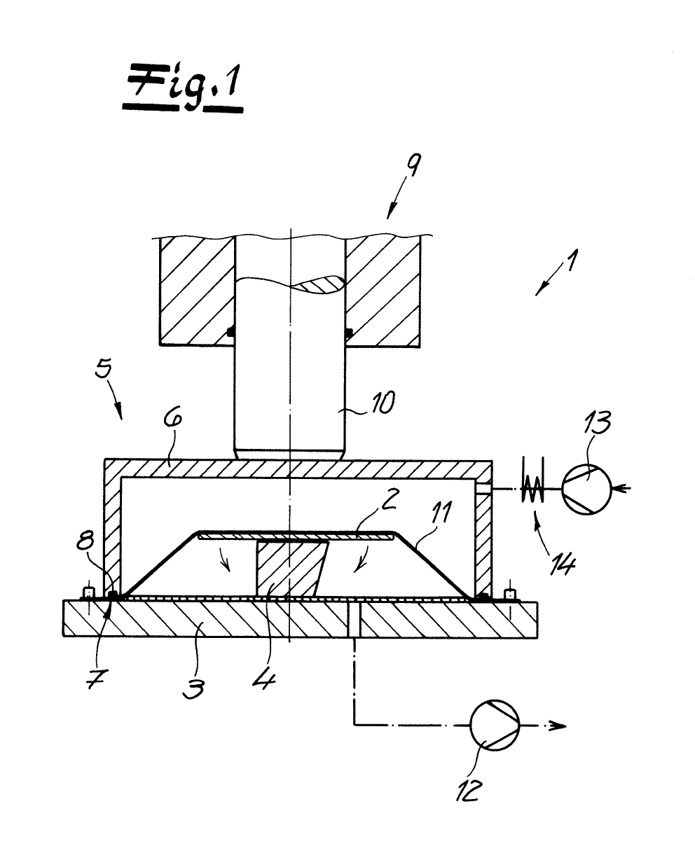

FIG. 1 is a simplified view of a membrane press according to the invention,

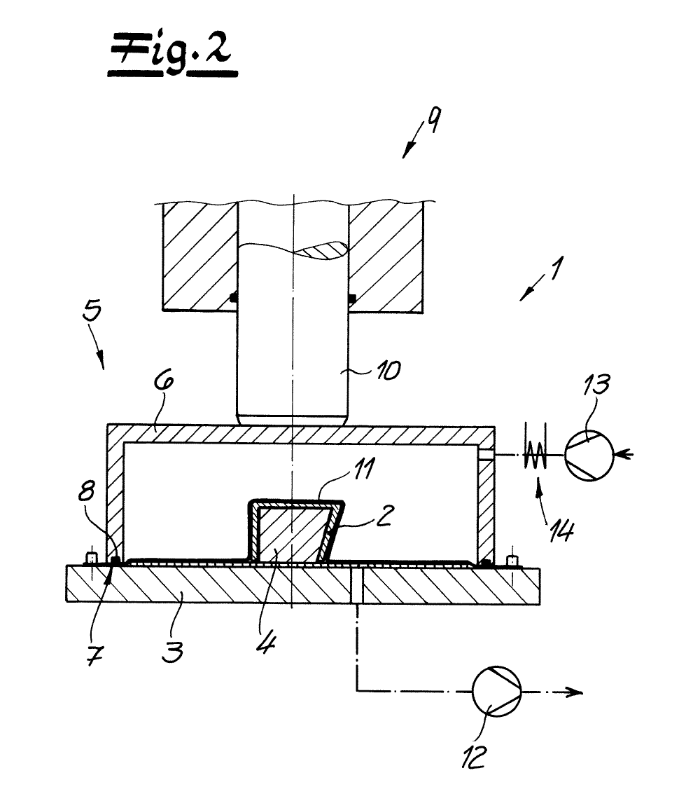

FIG. 2 shows the press of FIG. 1 in another functional position,

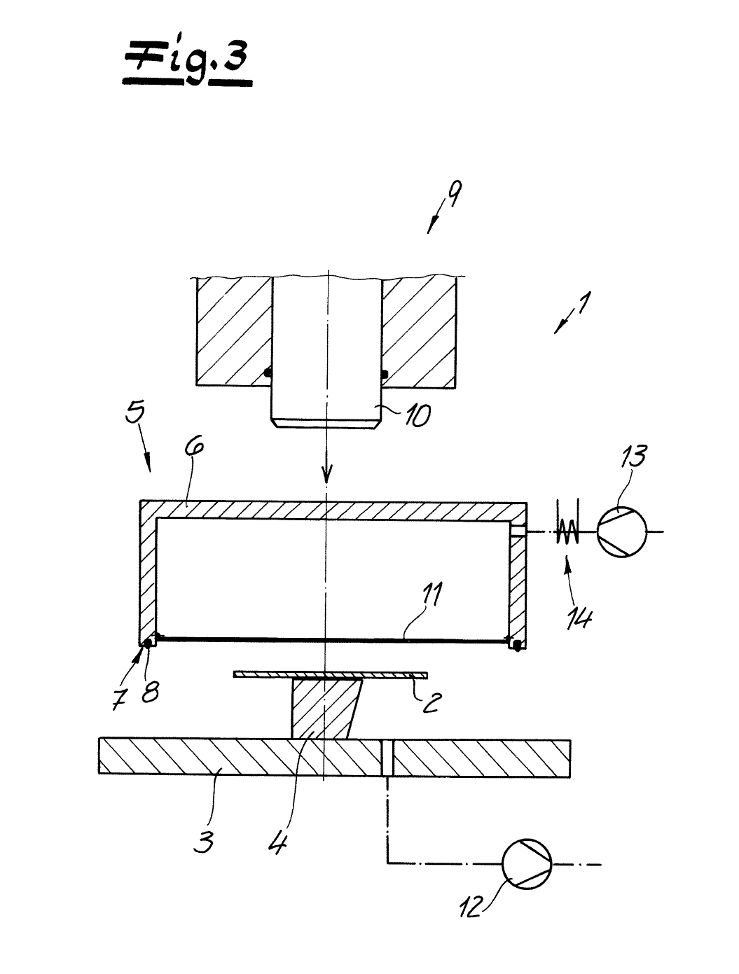

FIG. 3 shows a modified embodiment of the press according to FIG. 1,

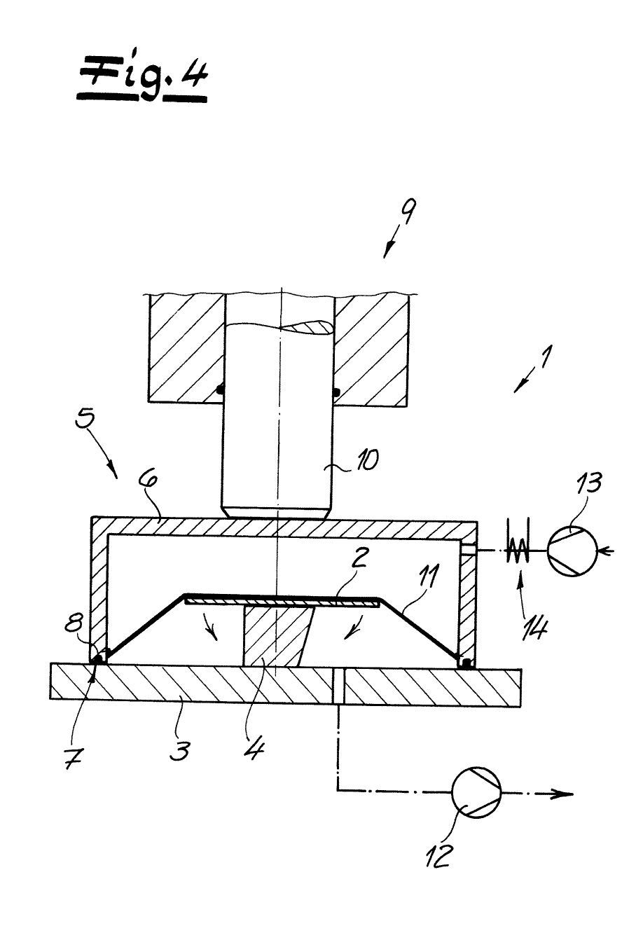

FIG. 4 shows the press pf FIG. 3 in another functional position,

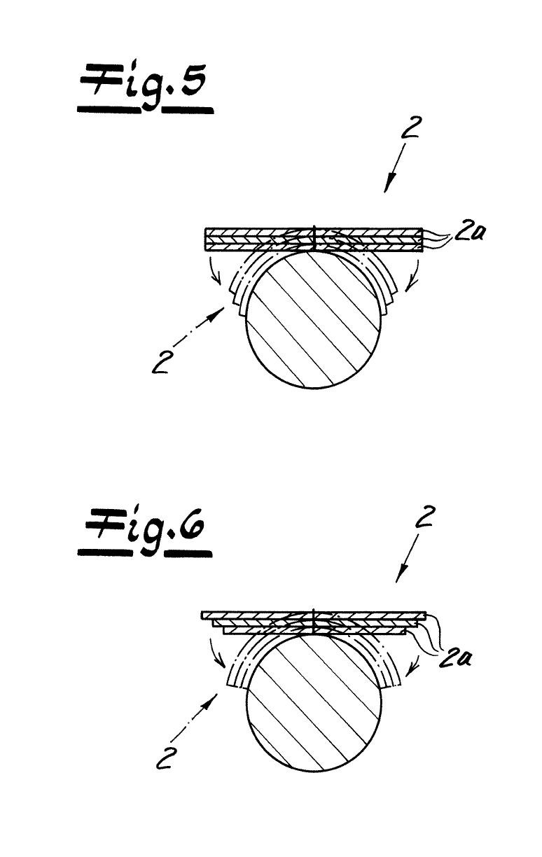

FIG. 5 shows a first embodiment of a process for shaping a multilayer organic sheet, and

FIG. 6 shows a second embodiment of a process for shaping a multilayer organic sheet.

The figures show a membrane press 1 for making a part from fiber composite. In such a membrane press, a part is manufactured from fiber composite by shaping a thermoplastic semifinished product, for example an organic sheet 2. Here, the membrane press 1 has a lower element 3 formed as a press table supporting a mold 4 that is a negative of the part to be manufactured. Moreover, the press 1 has an upper element 5 that has a hood-like pressure case 6 that can be sealed against the lower element 3. For this purpose, the lower, annular front edge 7 of the pressure case 6 that can be placed on the press table is provided with a circumferential seal 8. A press cylinder 9 acts on the upper element 5; here, the piston 10 of the press cylinder 9 is connected to the pressure case 6 so that the pressure case 6 is pressed by the cylinder 9, more particularly the piston 10 thereof, against the lower element 3. Moreover, the membrane press 1 is equipped with an elastic membrane 11 that can be stretched over the mold 4. Furthermore, a vacuum pump 12 is provided that here is connected to the lower element 3. Moreover, a superatmospheric pressure pump 13 can be optionally provided that here is connected to the upper element 5 and/or to the pressure case 6.

To shape an organic sheet 2, it is placed on the mold 4, and the membrane 11 is flexed and stretched over the mold 4 on top of the organic sheet 2.

The organic sheet is deformed so as to deform the part by applying a subatmospheric pressure by the vacuum pump 12 to the face of the membrane 11 facing the mold 4 and by applying a superatmospheric pressure by a superatmospheric pressure pump 13 to the face turned away from the mold 4, so that the organic sheet 2 is shaped against the mold to form the part.

The organic sheet 2 is heated before being placed into the press 1. Moreover, the mold 4 or at least its surface facing the organic sheet 2 is heated before and/or during the deformation. Finally, it is advantageous if the fluid medium that applies superatmospheric pressure to the membrane is heated. To achieve this, a heater 14 is shown schematically in the figures. Heaters for heating the organic sheet and for heating the mold are not shown.

FIG. 1 shows a first embodiment of such a membrane press in which the membrane 11 is secured to the lower element 3 and stretched over the mold 4. FIG. 1 shows the press after the organic sheet 2 has been placed onto the mold 4 and the membrane 11 has been stretched over the mold 4 with interposition of the organic sheet 2. Moreover, after placement of the organic sheet 2 and after the stretching of the membrane 11 on the lower element 3, the upper element 5 is lowered and sealed off. The subatmospheric pressure can be generated using the vacuum pump 12 before and/or after lowering of the upper element. After the upper element 5 has been lowered and sealed against the lower element 3, the superatmospheric pressure is applied to the interior of the pressure case 6. A provision can be made that the compressive force that holds the membrane press closed as the internal pressure increases is increased successively with rising of the internal pressure and thus adapted thereto. FIG. 2 shows the press after superatmospheric pressure and subatmospheric pressure have built up, with the deformed organic sheet 2.

FIGS. 3 and 4 show a modified embodiment of such a membrane press in which the membrane is not secured to the lower element 3, but rather to the upper element 5, namely to the pressure case 7 [6] thereof, and elastically biased. After placement of the organic sheet 2 onto the mold 4, the pressure case 6 is lowered and, at the same time, the membrane is stretched over the mold with interposition of the organic sheet 2 (FIG. 4). After the press has been closed, the subatmospheric pressure and the superatmospheric pressure are built up so that the organic sheet 2 is deformed and the part made.

The organic sheet 2 can be composed of a plurality of individual organic sheet layers 2a that are placed together to form the organic sheet 2 and deformed in the press. The geometry of the layers 2a can be coordinated with one another such that the individual layers 2a are offset relative to one another during deformation, thereby altering the edge geometry of the part. This option is illustrated in FIGS. 5 and 6. According to FIG. 5, the individual layers 2a are placed together to form an organic sheet 2 with square edges. During deformation, the individual layers are offset relative to one another, so that a part with beveled edges is made.

By contrast, FIG. 6 shows an embodiment in which the individual layers 2a of the organic sheet 2 are not flush with one another, but rather form an angled edge so that a part with a square edge without a bevel is then created during deformation.

In principle, the illustrated press can be used to shape not only organic sheets but other thermoplastic semifinished products as well.

According to the invention, the mold 4 is made of a porous material, particularly of aluminum. A particular advantage of this embodiment is the application of a full-surface vacuum over the entire surface to be shaped.

In the context of the invention, flat or shaped parts such as aircraft wings, flaps for aircraft wings, etc., can be especially preferably made.

The figures have been described with reference to the preferred use of organic sheets and/or organic sheet layers. However, other thermoplastic, semifinished (fiber composite) products and, in particular, semifinished products composed of a plurality of individual layers that are placed loosely (in non-consolidated form) into the press can also be processed in the manner shown.

1. A method of making a part from fiber composite by deformation of a thermoplastic semifinished product in a membrane press, the method comprising the steps of:
providing in the membrane press a mold that is at least partially air permeable;
placing a semifinished product onto or against the mold as a workpiece;
flexibly stretching an elastic membrane over the mold to form a closed space containing the semifinished product; and
deforming the semifinished product to form the part by drawing air out of the space through the partially air-permeable mold and thereby applying a subatmospheric pressure to the membrane on its face turned toward the mold, so that the semifinished product is shaped against the mold.

2. The method defined in claim 1, wherein the mold is made of a porous material.

3. The method defined in claim 1, further comprising the step, in order to shape the semifinished product, of:
applying to the membrane on the face turned away from the mold by a superatmospheric pressure that is at least 10 bar.

4. The method defined in claim 1, further comprising the step of:
heating the semifinished product before or after placement into the press.

5. The method defined in claim 1, further comprising the step of:
heating the mold or at least its surface turned toward the semifinished product before or during the deformation.

6. The method defined in claim 3, further comprising the step of:
heating a fluid medium that applies the superatmospheric pressure to the membrane.

7. The method defined in claim 1, further comprising the step of:
using an organic sheet as the semifinished product.

8. The method defined in claim 7, wherein the semifinished product is a prefabricated semifinished product that is composed of a plurality of layers that are placed together before being placed into the press.

9. The method defined in claim 1, wherein the membrane is made of silicone or has a thickness of at least 1 mm, or a stretch-to-break of at least 500%.

10. A press for making a part from fiber composite, the press comprising:
an at least partially air-permeable mold;
a lower element against/on which the mold and a thermoplastic sheet atop the mold are supported;
an upper element having a pressure case that can be sealed against the lower element;
a press cylinder that acts on the upper element or on the lower element, to push the elements together;
a membrane that can be stretched over the mold between the elements; and
a vacuum pump that applies a subatmospheric pressure through the partially-air permeable mold to one face of the membrane and thereby press the membrane down against the sheet and thereby deform the sheet to conform to a shape of the mold.

11. The press defined in claim 10, wherein the mold is made at least in some areas of a porous light metal.

12. The press defined in claim 10, further comprising:
a superatmospheric pressure pump that can apply a superatmospheric pressure to the other face of the membrane.

13. The press defined in claim 10, wherein the membrane is secured to the lower element and can be stretched over the mold, or is secured in an elastically biased manner on the upper element.

14. The press defined in claim 10, wherein the mold is at least partially formed of a porous material having a filter mesh of from 5 μm to 250 μm or a pore size of from 0.1 mm to 3 mm.

15. The press defined in claim 10, wherein the mold is at least partially made of porous aluminum.
